(19) United States
(12) Patent Application Publication
(10) Pub. No.: US 2026/0140982 A1
(43) Pub. Date: May 21, 2026

(54) DATA INTEGRATION TOOL THAT INCORPORATES GENERATIVE AI CAPABITLIES AT LARGE DATASET SCALE

(71) Applicant: Matillion Limited, Salford (GB)

(72) Inventors: Edward George Thompson, Ness (GB); Shane Paul Darren Booth, Manchester (GB); Charles Timothy Aylott, Farnham (GB)

(21) Appl. No.: 18/949,545

(22) Filed: Nov. 15, 2024

(51) Int. Cl. G06F 16/33; G06F 16/338

(52) U.S. Cl. CPC G06F 16/3344; G06F 16/338

(57) ABSTRACT

With the disclosed data integration tool, a data pipeline segment is built that captures configuration information incorporating a generative AI model (e.g., via application programming interface (API) requests) into a transformation/analysis stage for a dataset, including configuration information for prompt construction. When the data pipeline segment is run, the data integration tool builds a prompt for each entry or row of the dataset based on the configuration information, submits the prompt to the generative AI model, and obtains a response according to the task(s) requested in the prompt. The data integration tool accumulates the responses into a database or repository which allows the data pipeline segment or another data pipeline segment to consume the responses from the generative AI model that have been output for the dataset.

### BACKGROUND

The disclosure generally relates to digital data processing and information retrieval (e.g., CPC subclass G06F/00) and ETL procedures (e.g., CPC subclass CPC G06F/254).

ETL (extract, transform, load) is a data integration process that was introduced in the 1970s. The ETL process extracts data from multiple data sources, cleans and organizes (i.e., transforms) the extracted data for the intended use and/or target system, and loads the transformed data into a target system (e.g., data warehouse or data lake). ELT (extract, load, transform) is a similar data integration process that defers transformation until after the extracted raw data has been loaded into the target system.

The rise of cloud computing has introduced “ETL/ELT pipelines” or “data pipelines.” ETL/ELT pipeline refers to the implementations or collection of processes and tools for ETL/ELT in a cloud computing environment that involves not only multiple data sources but heterogeneous data sources. In some cases, “cloud ETL” or “cloud ELT” is used instead of data pipeline. While “data pipeline” and “ETL/ELT pipeline” are sometimes used interchangeably, some use “data pipeline” to refer more specifically to a data integration process that includes streaming data sources or “real-time” data sources. However, it is more common for data pipelines to refer to the processes and tools that collectively implement ETL/ELT regardless of the data sources being streamed or “real-time” data sources. “Data pipeline” suggests the flow of data over a pipeline from sources, through a series of processing steps or components that implement the processing steps, to a destination or sink. ETLT refers to a data integration approach that is a hybrid of ETL and ELT which performs data transformations both before and after loading data into a target location.

### BRIEF DESCRIPTION OF THE DRAWINGS

Embodiments of the disclosure may be better understood by referencing the accompanying drawings.

FIG. 1 depicts a graphical user interface (GUI) 100 displaying a data pipeline segment that includes a component for integrating a LLM into the data pipeline.

FIG. 2 depicts a GUI 200 displaying a data pipeline segment that consumes LLM output.

FIG. 3 is a diagram that depicts a pipeline manager orchestrating a data pipeline segment that includes an LLM component and a pipeline segment that consumes the output of the transformation pipeline segment.

FIG. 4 is a flowchart of example operation for incorporating generative AI into a cloud data pipeline for large scale datasets.

FIG. 5 depicts an example computer system having a data integration tool with generative AI capability incorporation.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

A “prompt” refers to input to a foundation model (e.g., a generative artificial intelligence (AI) model or large language model (LLM)) and prompting refers to the act of submitting a prompt to a model to perform inference based on the submitted prompt. A prompt at least includes a task for the model and one or more instructions for the task in natural language. A prompt can also include context, constraints, and examples. In other words, a prompt is a natural language task instruction(s) and other information that can assist the model in performing the task successfully. A prompt can have more than one task instruction, and prompts can be chained to incorporate responses from the model into a subsequent prompt. A prompt can be entered by a user and/or constructed from a prompt template.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Overview

Generative artificial intelligence (AI) is being used in many products and services, such as Software-as-a-Service and customer support chatbots. However, these interactions are limited in scale and often involve receipt of a request from a user at a front-end interface of an application that uses generative AI. Disclosed herein is a data integration tool that facilitates integrating generative AI capabilities into a data pipeline for transformation/analysis that yields a generative AI augmented dataset. This allows for seamless application of generative AI capabilities to a large-scale dataset. With the data integration tool, a data pipeline is built that captures configuration information integrating a generative AI model (e.g., via application programming interface (API) requests) into a transformation/analysis stage for a dataset, including configuration information for prompt construction. When the data pipeline is run, the data integration tool builds a prompt for each entry or row of the dataset based on the configuration information, submits the prompt to the generative AI model, and obtains a response according to the task(s) requested in the prompt. The data integration tool accumulates the responses into a database or repository which allows the data pipeline or another data pipeline to consume the responses from the generative AI model that have been output for the dataset.

### Example Illustrations

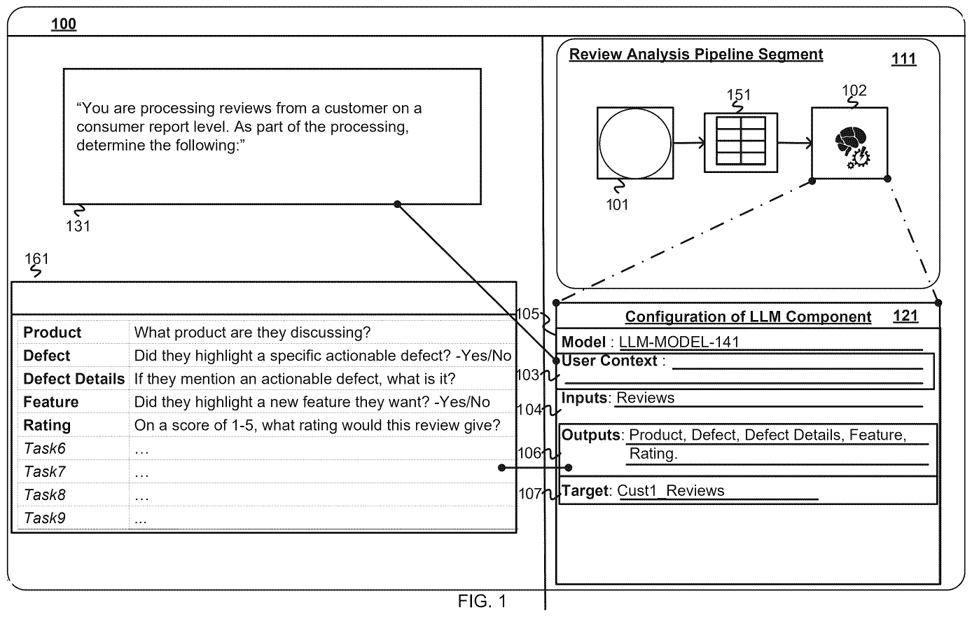

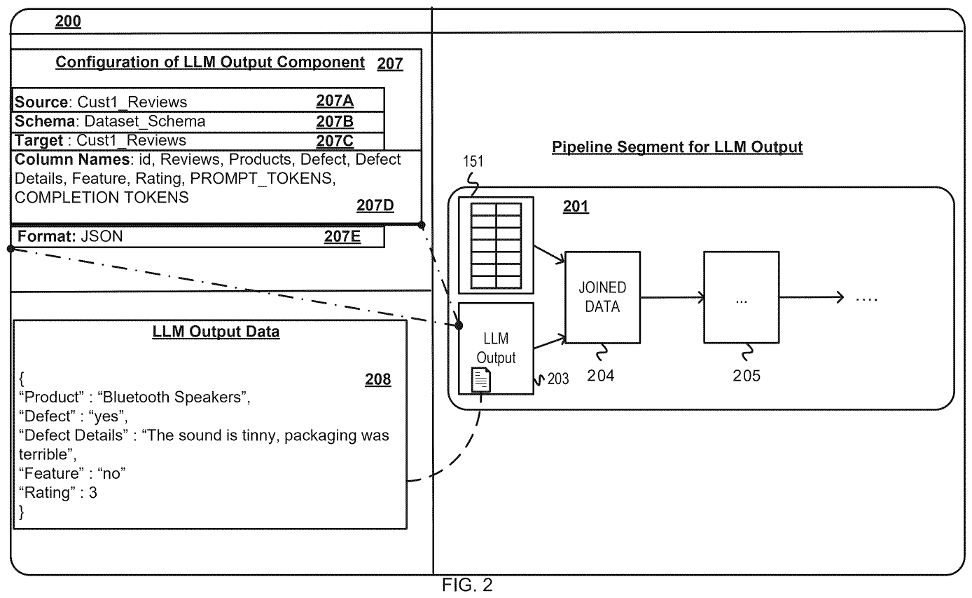

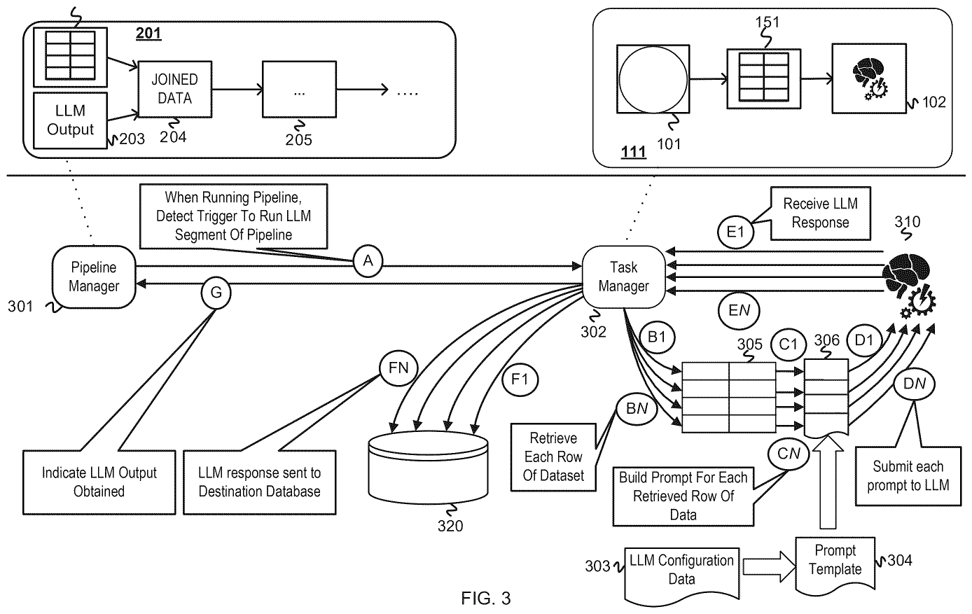

FIGS. 1 and 2 are diagrams depicting example configurations for data pipeline segments. The diagrams of configuration information in FIG. 1 and FIG. 2 are illustrated to assist in understanding the diagram depicted in FIG. 3. Segments of a data pipeline can be represented differently with different tools or applications and may not be graphically rendered or presented. If presented, data pipeline segments are representations of logical segments of a data pipeline and not necessarily a program code or modularization of program code.

FIG. 1 depicts a graphical user interface (GUI) 100 displaying a data pipeline segment 111 that includes a component for integrating a LLM into a data pipeline. An example pipeline segment 111 contains graphical elements 101, 151, 102 respectively representing a triggering component, a dataset, and a LLM component. These graphical elements 101, 151, 102, have been arranged in the GUI 100 of a data integration tool to form the transformation pipeline segment 111 identified as a Review Analysis Pipeline Segment in FIG. 1. For brevity, the description will refer to the graphical elements and corresponding components as if they were the same. The triggering component 101 is used to begin running the transformation pipeline segment 111. The GUI 100 is also depicted with a configuration window 121 for the LLM component 102. The configuration window 121 includes fields 103-107. FIG. 1 depicts expanded views 131, 161 of the fields 103, 106, respectively.

The configuration window 121 is an example of the information that can be configured to connect to a LLM, construct prompts for the LLM, and submit the prompts to the LLM. The configuration window 121 is depicted with the example information below with corresponding labels in parentheses.
Model: LLM-MODEL-141 (105)
User Context: (103)
Inputs: Reviews (104)
Outputs: Product, Defect, Defect Details, Feature, Rating (106)
Target: SQL_Database_1 (107)
   The configurable field 105 within the GUI 100 is designated for identifying an AI model. The fields corresponding to prompt building include the user context field 103 and the outputs field 106. The expanded view 131 provides an example of context that will be incorporated into a prompt. The expanded view 161 depicts an example of values that can be set to define tasks and/or task instructions for a LLM. The expanded view 161 is illustrated with 5 tasks corresponding to the task labels identified above in the outputs field. In the expanded view 161, each of the task labels is associated with a task instruction. When building a prompt, the data integration tool can include the task label and the task instruction into the prompt or extract the task instruction without the task label. The data integration tool can be implemented to present a drop-down menu with the model capabilities as the options for tasks. When selected, the data integration tool can load a previously crafted natural language task instruction for the selected text. The inputs field 104 corresponds to the dataset represented by the GUI element 151. When building a prompt, the data integration tool will use the label “Reviews” specifying the targeted field(s) of interest in the source dataset to the prompt. Of course, multiple fields or columns can be selected and incorporated into prompts. The data integration tool can be considered as building a prompt template from the text in the user context field 103 and the text of the outputs field 106 and creating a prompt based on that template for each entry or row of the dataset represented by the GUI element 151. The Target field 107 accepts as input an identifier of a destination for responses/outputs from the LLM (i.e., a dataset identifier). FIG. 2 depicts a GUI 200 displaying a data pipeline segment 201 that consumes LLM output. The transformation pipeline segment 201 in the GUI 200 contains graphical elements 151, 203, 204, and 205 respectively representing the source dataset that is the input to a LLM, a sink for output/responses from a LLM (“LLM output”), a joined dataset of the source dataset and LLM output, and an element representing a variable number of downstream components inside the transformation pipeline segment 201. Similar to FIG. 1, the description refers to the graphical elements and corresponding components or datasets as if the same for brevity. The source dataset 151 and the LLM output component 203 are arranged to input to the joined dataset 204 for collating entries of the source dataset 151 and the LLM output data. The joined dataset is arranged to output to a downstream component 205, which can be of varying function. The GUI 200 is also depicted with a configuration window 207 for the LLM output component 203, and an example of LLM output data 208.

The configuration window 207 is an example configuration for the LLM output component 203. The configuration window 207 depicts fields 207A-207E for accepting configuration information. The configuration window 207 is depicted with the fields below with corresponding labels in parentheses.
Source: Cust1_Reviews (207A)
Schema: Dataset_Schema (207B)
Target: Cust1_Reviews_Processed (207C)
Column Names: id, Reviews, Products, Defect, Defect Details, Feature, Rating, PROMPT_TOKENS, COMPLETION TOKENS (207D)
Format: JSON (207E)
   The source field 207A holds the value “Cust1_Reviews” 207A, which corresponds to the database identified in FIG. 1 in the Target field 107. In this example, the source and destination are the same, but a variety of scenarios can occur that involve other transformations and/or intermediary databases. For example, after an LLM provides its output to a destination database, additional pipeline segments may move and transform the dataset that includes the LLM output causing the further modified dataset to be placed in a location different than the original destination.

The schema field 207B accepts as input an identifier of a schema. The example is labeled “Dataset_Schema” and is the defined schema of the dataset identified in the source field (207A).

The column names field 207D identifies the columns/fields that will be provided from the data pipeline segment in FIG. 1. As illustrated, the column names field 207D includes the name “id” which identifies the data entry/row and “Reviews” which corresponds to the column/field of the source dataset that was included in the prompt to the LLM. The column names in field 207D also include: “Products”, Defect”, “Defect Details”, “Feature”, and “Rating.” These column names correspond to the different outputs in the LLM responses according to the LLM tasks described with respect to FIG. 1. Thus, the program code underlying the LLM output 203 will parse the dataset in SQL_Database_1 to arrange the data according to the column names. The column names field 207D also includes the names “PROMPT_TOKENS” and “COMPLETION TOKENS”. The PROMPT_TOKENS column in the dataset will include, per row, the quantities of tokens in the prompt submitted to the LLM to obtain the outputs for the corresponding row. The “COMPLETION_TOKENS” column will include, per row, the quantities of tokens in the LLM response for the corresponding row.

The format field 207E identifies the format for the LLM output.

The LLM output data 208 is one example response from an LLM. The LLM output data 208 is:

{
“Product”: “Bluetooth Speakers”,
“Defect” : “yes”,
“Defect Details” : “The sound is tinny, packaging was terrible”,
“Feature” : “no”
“Rating” : “3”,
}

The LLM output data shown above contain labels corresponding to the labels used when configuring LLM tasks in FIG. 1 within the output field 106. The LLM output data includes the results of a product identification task, detection of a review mentioning a defect, elaboration on any mentioned defect in the review, whether a review referred to a feature of a product, and a scoring task for the product review. The LLM output data 208 are presented in JavaScript® object notation (JSON) format. The label “Product” refers to the task labeled Product, which had the corresponding question: “What product are they discussing?”. The LLM output 208 shows the response to that question: “Bluetooth Speaker”. For the other tasks, the LLM responded that the review indicated a defect in the product, included details about that defect, responded that no feature of the product was mentioned in the review, and rated the sentiment of the review as a 3.

The element 205 represents the various possible downstream components. Downstream components can provide a variety of operations or transformations on the joined dataset 204. As the GUI 201 illustrates only a data pipeline segment, additional components not illustrated here can exist downstream in the data pipeline which will perform additional tasks.

FIG. 3 is a diagram that depicts a pipeline manager orchestrating a data pipeline segment that includes an LLM component and a data pipeline segment that consumes the output of the LLM data pipeline segment. Embodiments are not required to separate the incorporation of a LLM and consumption of the LLM responses into different pipeline segments. FIG. 3 depicts the distinct pipeline segments to focus on the pipeline manager operations related to the LLM component while still illustrating consumption of that LLM augmented dataset with other typical transformation operations. FIG. 3 depicts the pipeline segment 111 from FIG. 1 and the pipeline segment 201 from FIG. 2. FIG. 3 also depicts a process of the underlying program code as a pipeline manager 301, sometimes referred to as a workflow engine, acting as manager for the pipeline segment 201 and the pipeline segment 111. FIG. 3 also depicts the underlying program code (or instantiated program code) as a task manager 302 spawned or instantiated by the pipeline manager 301 to perform a task, in this case running the LLM transformation flow.

FIG. 3 is annotated with a series of letters A, B1-BN, C1-CN, D1-DN, E1-EN, F1-FN, and G representing stages of one or more operations. The stages B1-BN, C1-CN, D1-DN, E1-EN, F1-FN correspond to iterative operations over a dataset. Stages B1, C1, D1, E1, and F1 are performed for a first entry. Then stages B2, C2, D2, E2, and F2 are performed for the second entry of a dataset. Finally, stages BN, CN, DN, EN, and FN are performed for a Nth entry. These stages depicted in FIG. 3 can be considered as abstracted stages that coarsely capture the operations at a high level to introduce the concept of the LLM prompt configuration pipeline segment functionality. Although these stages are ordered for this example, the stages illustrate one example to aid in understanding this disclosure and should not be used to limit the claims. Subject matter falling within the scope of the claims can vary from what is illustrated.

At stage A, the pipeline manager 301 detects a trigger to run the pipeline 111 while running the pipeline 201. A data integration tool that displays the pipeline segment 201 may detect a command or event on a graphical element to run the pipeline 201. Since the pipeline segment 201 includes the LLM output component 203 configured to run the pipeline segment 111, the pipeline manager 301 causes execution of the program code underlying the pipeline segment 111 which instantiates the task manager 302.

At each of stages B1-BN, the task manager 302 retrieves specified columns/fields of individual rows from the dataset represented by the GUI element 151. The task manager 302 may maintain a pointer or counter to progress through the dataset.

At each of stages C1-CN, the task manager 302 builds a prompt for each retrieved row of data. The collection of prompts across stages C1-CN is depicted as prompts 306. The task manager 302 reads the configuration data associated with the LLM component 102. As one example, the task manager 302 initially constructs a prompt template 304 with the text of user context configuration and the text of outputs configuration (LLM configuration data 303), examples of which were previously illustrated in FIG. 1. The task manager 302 also reads the identifier for the data to be processed and writes the identifier (“data variable name”) into the prompt template 304. After assembling the text that specifies task(s), context, constraints (if applicable), and variable name to form the prompt template 304, the task manager 302 can store the prompt template 304 for use with each retrieved row of a dataset. As data in column(s)/field(s) of each row is retrieved, the task manager 302 replaces the variable name with the retrieved data. For instance, the task manager replaces the data variable name in the prompt template 304 with a product review in row 1 at stage C1 to generate a first of the prompts 306.

At each of stages D1-DN, the task manager 302 submits each prompt built in stages C1-CN to a LLM 310 as specified in the configuration. The task manager 302 submits each prompt according to an API of the LLM 310. The manner of connection and interaction with the LLM 310 will be in the configuration. The specification of a model or service in the configuration of the LLM component 102 causes the task manager 302 to retrieve any one of program code, code snippets, application messages, etc. for submitting prompts or requests to the model/service. At stage D1, the task manager 302 submits the first of the prompts 306 that was built from the LLM configuration data 303 and the data in specified column(s)/field(s) of the first data entry in the source dataset. At stage DN, the task manager 302 submits the Nth of the prompts 306 that was built from the LLM configuration data 303 and data in specified column(s)/field(s) of the Nth data entry in the source dataset.

At each of stages E1-EN, the task manager 302 receives a response from the LLM 310. In some cases, the task manager 302 assigns an identifier for each LLM response to associate the response with the appropriate data entry. At stage E1, the task manager 302 receives a first response and associates the first response with the first data entry. At stage EN, the task manager 302 receives an Nth response and associates it with the Nth data entry in the source dataset.

At each of stages F1-FN, the task manager 302 stores the received responses to a database 320. Implementations can preserve the appropriate relationships between source data entries and the LLM responses differently. For instance, the task manager 302 can use the same identifier of a data entry in the source dataset to identify the corresponding LLM response or a derived identifier. This allows the LLM responses to be stored separately from the source dataset while maintaining the associations. In some cases, the source dataset is updated with the received LLM responses.

At stage G, the task manager 302 notifies the pipeline manager 301 that it has completed obtaining the LLM outputs. With the LLM outputs, the pipeline manager 301 can proceed with the pipeline segment 201 and generate reports and/or perform analysis based on the source dataset 151 augmented with the LLM outputs.

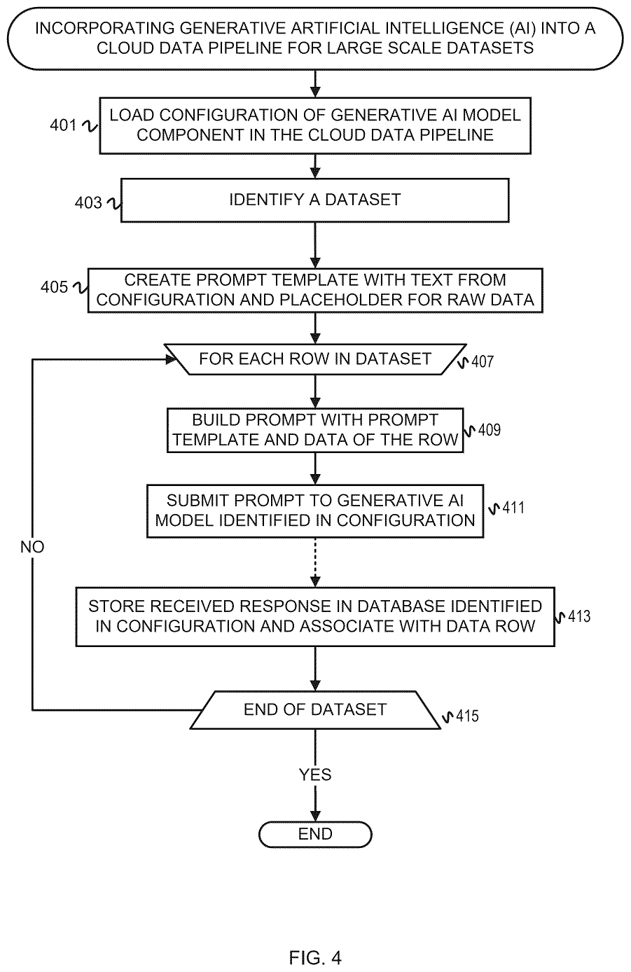

FIG. 4 is a flowchart of example operation for incorporating generative AI into a cloud data pipeline for large scale datasets. Incorporating generative AI capabilities into a cloud data pipeline facilitates leveraging model capabilities to augment a dataset. The example operations of FIG. 4 presume a data pipeline has been designed with the previously described model component that has configuration information for communicating with a generative AI model and for building prompts.

At block 401, a pipeline manager loads a configuration of a generative AI model component in the cloud data pipeline. The configuration indicates a configuration that has been input for the AI model component. The configuration specifies an AI model or service, and various pieces of text to form a prompt template.

At block 403, the pipeline manager identifies a dataset. A dataset will likely have a name but may also be associated with a data source identifier (e.g., table name, repository identifier, etc.). The data pipeline may expressly identify the data source, or the data source may be indicated in the configuration of the generative AI model component.

At block 405, the pipeline manager creates a prompt template. The pipeline manager creates the prompt template with text from the configuration that was loaded (401). For instance, the pipeline manager begins with context (e.g., assigning the model a role) and appends the tasks and/or task instructions that were selected or input into the configuration fields. The context can vary depending on the needs of the end-user. For example, an executive will have a different lens for perceiving data than an accountant or product manager. These different perspectives can be written into the context. The user context provides generative AI model 310 the ability to frame the tasks that are included within the prompt. Implementations can include generic examples for few shot prompting for one or more of the tasks. Finally, the pipeline manager inserts a placeholder into the prompt template for inserting data from the identified dataset.

At block 407, the pipeline manager begins iterating through the entries or rows of the identified dataset. The pipeline manager reads or retrieves each row of the dataset to build a prompt and obtain a response that augments and/or provides insight to the raw data of the row.

At block 409, the pipeline manager builds a prompt with the prompt template and data of the row. For instance, the pipeline manager retrieves data of the current row and inserts the retrieved data in place of the placeholder.

At block 411, the pipeline manager submits the prompt to the generative AI model identified in the configuration. The pipeline manager may load or retrieve program code, API keys, and/or message formats for communicating with a front-end of the generative AI-model, service providing the generative AI model, or application using the generative AI model. For example, the pipeline manager may identify an API defined request message and populate the request message with an API key and the built prompt. A dashed line from block 411 to block 413 represents the asynchronous nature of submitting a prompt and waiting for a response.

At block 413, the pipeline manager stores a response received from the generative AI model. The pipeline manager may extract output from a response. To illustrate, a generative AI model may append additional explanatory text in a response that the pipeline manager is programmed to remove or store separately from the specified outputs (e.g., rating or summary). The pipeline manager may assign an identifier to the response or organize output of the responses in the store to ensure appropriate association with raw data entries. The destination for accumulating model outputs may be specified in the generative AI model component configuration or in the data pipeline (e.g., the pipeline is built with the generative AI model component generating output to a defined destination dataset).

At block 415, the pipeline manager determines whether the end of the dataset has been reached. The pipeline manager will receive an indication, for example from a driver, that the dataset has been traversed. In some implementations, the pipeline manager may encounter a null value or end of file marker. If the end of the dataset has not been reached and there is another row of data in the dataset, operational flow returns to block 407. If the pipeline manager determines that the end of the dataset has been reached, then operational flow ends. In some cases, a notification that the generative AI processing is complete is generated, for example to cause another data pipeline to consume the accumulated model outputs.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

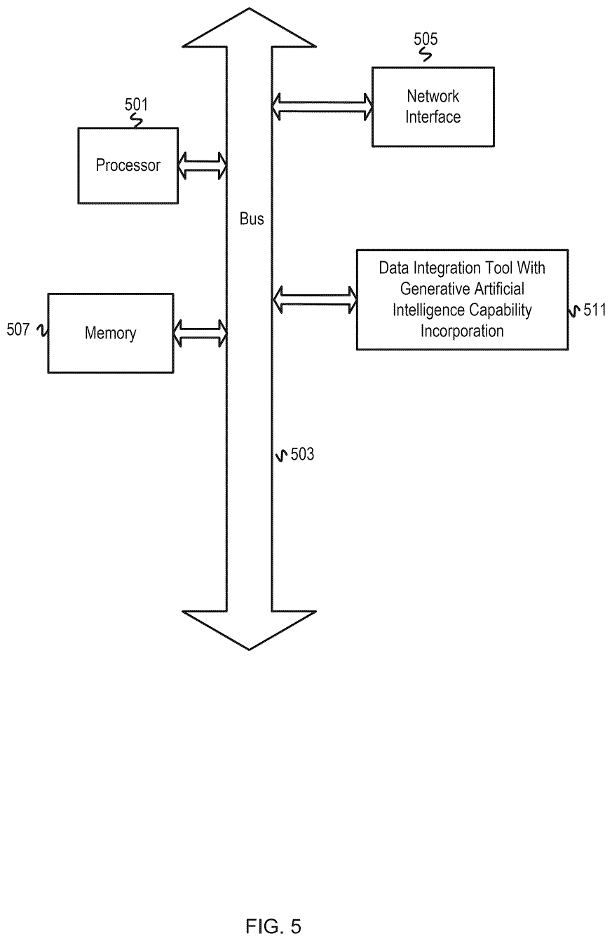

FIG. 5 depicts an example computer system having a data integration tool with generative AI capability incorporation. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes a data integration tool 511 with generative AI capability incorporation. The data integration tool 511 can be provided as a software-as-a-service or an on-premise or customer environment solution. The data integration tool 511 allows for a data pipeline to be created that includes a component representative of generative AI capability. A data pipeline will often extract a large-scale dataset (i.e., a dataset with entries possibly in the hundreds to the millions). The data integration tool 511 includes program code that, when executed, generates a prompt template from configuration data that specifies a model, context, and tasks and/or task instructions. The data integration tool assembles the text of the configuration data corresponding to the context and task(s) and/or task instruction(s) into a prompt template. The data integration tool then applies generative AI capabilities as specified in the prompt template to each data entry by creating a prompt from the prompt template and the data entry. Thus, the generative AI capability is flexibly and efficiently applied at an entry granularity to a large-scale dataset. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501 and the network interface 505 are coupled to the bus 503. Although illustrated as being coupled to the bus 503, the memory 507 may be coupled to the processor 501.

1. A method comprising:
in response to selection of a representation of a language model component in a first data pipeline displayed in a data integration tool, capturing configuration data for the language model component, wherein the configuration data comprises an identifier of a language model, a task for the language model, and one or more task instructions to perform the task;
running the first data pipeline to apply one or more capabilities of the language model to a first dataset, wherein running the first data pipeline comprises,
for each data entry in the first dataset, generating a prompt according to the configuration data and the data entry and submitting the generated prompt to the language model; and
accumulating outputs in responses from the language model.

2. The method of claim 1 further comprising aggregating the outputs with the first dataset.

3. The method of claim 2, wherein aggregating the outputs with the first dataset comprises collating the outputs from the language model with corresponding entries in the first dataset.

4. The method of claim 1, wherein the configuration data further comprises context for the language model, wherein the context comprises at least one of a role, a constraint, and an example.

5. The method of claim 1, wherein generating a prompt according to the configuration data and the data entry comprises retrieving, from the data entry, data from each field of the data entry specified in the configuration data and inserting the retrieved data into the prompt.

6. The method of claim 1, wherein accumulating outputs in responses from the language model comprises, for each response from the language model, extracting one or more outputs from the response and storing the extracted one or more outputs to a destination specified for the outputs in the configuration data.

7. The method of claim 1 further comprising:
building a prompt template from first and second texts in the configuration data, wherein the first text indicates a context for the language model and the second text indicates the task and one or more task instructions,
wherein generating the prompt for each data entry comprises generating the prompt with the prompt template and the data entry.

8. A non-transitory, machine-readable medium having program code stored thereon, the program code comprising instructions to:
capture configuration data for prompting a language model, wherein the configuration data comprises an identifier of a language model, a task for the language model, and one or more task instructions to perform the task; and
run a first data pipeline associated with the captured configuration data to apply one or more capabilities of the language model to a first dataset, wherein the instructions to run the first data pipeline comprise,
for each data entry in the first dataset, generate a prompt according to the configuration data and the data entry and submit the generated prompt to the language model; and
accumulate outputs in responses from the language model.

9. The non-transitory, machine-readable medium of claim 8, wherein the program code further comprises instructions to aggregate the outputs with the first dataset.

10. The non-transitory, machine-readable medium of claim 9, wherein the instructions to aggregate the outputs with the first dataset comprise instructions to collate the outputs from the language model with corresponding entries in the first dataset.

11. The non-transitory, machine-readable medium of claim 8, wherein the configuration data further comprises context for the language model, wherein the context comprises at least one of a role, a constraint, and an example.

12. The non-transitory, machine-readable medium of claim 8, wherein the instructions to generate a prompt according to the configuration data and the data entry comprise instructions to retrieve, from the data entry, data from each field of the data entry specified in the configuration data and to insert the retrieved data into the prom.

13. The non-transitory, machine-readable medium of claim 8, wherein the instructions to accumulate outputs in responses from the language model comprise instructions to, for each response from the language model, extract one or more outputs from the response and store the extracted one or more outputs to a destination specified for the outputs in the configuration data.

14. The non-transitory, machine-readable medium of claim 8, wherein the program code further comprises instructions to:
build a prompt template from first and second texts in the configuration data, wherein the first text indicates a context for the language model and the second text indicates the task and one or more task instructions,
wherein the instructions to generate the prompt for each data entry comprises generating the prompt with the prompt template and the data entry.

15. The non-transitory, machine-readable medium of claim 8, wherein the program code further comprises instructions to present a graphical user interface of a data integration tool for creating data pipelines, wherein the instructions to present the graphical user interface comprise instructions to present a selectable graphical element that represents a language model and to present configurable fields for the graphical elements that represents the language model, wherein the instructions to capture the configuration data comprise instructions to capture the configuration data in the configurable fields.

16. An apparatus comprising:
a processor; and
a machine-readable medium having instructions stored thereon that are executable by the processor to cause the apparatus to,
capture configuration data for prompting a language model, wherein the configuration data comprises an identifier of a language model, a task for the language model, and one or more task instructions to perform the task; and
run a first data pipeline associated with the captured configuration data to apply one or more capabilities of the language model to a first dataset, wherein the instructions to run the first data pipeline comprise,
for each data entry in the first dataset, generate a prompt according to the configuration data and the data entry and submit the generated prompt to the language model; and
accumulate outputs in responses from the language model.

17. The apparatus of claim 16, wherein the machine-readable medium further comprises instructions executable by the processor to cause the apparatus to collate the outputs from the language model with corresponding entries in the first dataset.

18. The apparatus of claim 16, wherein the configuration data further comprises context for the language model, wherein the context comprises at least one of a role, a constraint, and an example.

19. The apparatus of claim 16, wherein the instructions to accumulate outputs in responses from the language model comprise instructions executable by the processor to cause the apparatus to, for each response from the language model, extract one or more outputs from the response and store the extracted one or more outputs to a destination specified for the outputs in the configuration data.

20. The apparatus of claim 16, wherein the machine-readable medium further comprises instructions executable by the processor to cause the apparatus to:
build a prompt template from first and second texts in the configuration data, wherein the first text indicates a context for the language model and the second text indicates the task and one or more task instructions,
wherein the instructions to generate the prompt for each data entry comprises generating the prompt with the prompt template and the data entry.
